(19) United States
(12) Patent Application Publication
(10) Pub. No.: US 2021/0076653 A1
(43) Pub. Date: Mar. 18, 2021

(54) Multipurpose Fishing Rod Holder

(71) Applicant: Nathan R. Leigh, Jacksonville, FL (US)

(72) Inventor: Nathan R. Leigh, Jacksonville, FL (US)

(21) Appl. No.: 16/933,766

(22) Filed: Jul. 20, 2020

Related U.S. Application Data
(60) Provisional application No. 62/876,402, filed on Jul. 19, 2019.

(51) Int. Cl. A01K 97/10; A22C 25/06; A45F 3/44; A47B 9/16; A01K 97/06; A47B 13/16

(52) U.S. Cl. CPC A01K 97/10; A22C 25/06; A47B 13/16; A47B 9/16; A01K 97/06; A45F 3/44

(57) ABSTRACT

This Multipurpose Fishing Rod Holder includes an elongate horizontal planar member with a generally rectangular opening therethrough covered by a liftable cutting board and also has a removable tubular member sized for insertion of the handle of a fishing rod extending therethrough at an inclined angle so as to extend over the cutting board. There is a stake attached to and aligned with the tubular member which can be driven into an earthen surface for mounting the apparatus with the planar member positioned to serve as a fiat utility surface for the use of a fisherman. A removable container is positioned under the opening for use as a bait holder, while an opening in the rear facing surface is provided with a drink holder. A variety of slots are provided for a fisherman's knife and pliers with extra hooks, holes and rings for other uses. Finally, a ruler is provided down one or the long sides for measuring the “catch”.

### CROSS-REFERENCE TO RELATED APPLICATIONS

This application claims the benefit and priority of U.S. Provisional Application Ser. No. 62/876,402 titled “Multipurpose Fishing Rod Holder” filed Jul. 19, 2019, the same being incorporated herein by reference.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

### Field of the Invention

This invention pertains generally To the field of surf fishing. More particularly, this invention describes an improved multipurpose fishing rod holder, including a horizontal multipurpose planar member and a transverse stake and fishing rod holding member.

In the sport of surf fishing, the fisherman or woman uses a rod and reel to catch fish in shallow shoreline surf. Typically this involves casting a baited hook into turbulent surf conditions and waiting for a fish to take the bait. However, long waits can make standing and holding a line fatiguing. This leads to the use of a pole holding device of some type, usually comprising a section of tubing into which the handle of the rod can be placed to hold the rod in an upright or semi-upright position while waiting for a fish to strike. This section of tubing can be driven directly into the beach sand, or be attached to a stake that can be driven into the beach sand. While waiting the fisherman will typically set up a folding seat of some type and relax.

However, relaxation is not always easy in this situation. Conditions in the open sun and the sport itself often require a lot of movement back and forth to a parked vehicle nearby or other location to access a cooler for refreshments, get a measuring tape, get bait, get pliers, cut up bait, and/or take other actions related to both fishing and the recreational setting. Traversing broad stretches of sand or otherwise having to leave the site of the sport detract from the enjoyment of the fisherman and waste valuable fishing time. The only time a fisherman wants to go to the cooler is to put a fish in or get a new cold drink!

The inventor searched far and wide to find a product that provided all of the features needed without success, so he developed the instant invention, which incorporates an easily removable, sealable bait (Tupperware® type) container (that can be used to hold bait or food), a cutting board, knife holder, plier bolder, towel holder, cup holder, bottle opener, lure and tackle holders, a segmented fish measuring line, and two accessory hooks.

The frame of the invention (also referred to as the “Reel Buddy”) can be made out of wood, plastic or alloy metals with an attached, hinged cutting board type material that doubles as the lid for the bait tray. The “Reel Buddy” is currently designed to fit over the most common rod holders on the market—2″ PVC pipe, with or without an attached ¾″ galvanized steel pipe/stake. It can also be used with adapters that will allow it to clamp to the sides of boats, chairs etc. The center (mounting) hole is drilled to 1 ⅞″ at a 15 degree angle toward. the cutting hoard surface. This makes sure that the tackle being used or fish is hanging over or near the cutting hoard side and away from any drink placed in the drink holder at the opposite end. It also makes bait replacement easier.

The invention can be produced as one piece, standalone versions incorporating their own rod holder as well as retrofit kits that allow anglers that already have a rod holder to attach the “Reel Buddy” to it. These kits will include stainless steel hardware to replace existing screws on the ¾″ galvanized downpipe rod holder versions as well as set screws or clamps (depending on material used to make “Reel Buddy” frame) to ensure no slippage on both solid PVC downpipe and galvanized downpipe versions of rod holders driven into the sand.

### BRIEF DESCRIPTION OF THE DRAWINGS

FIG. 1A provides an overhead perspective schematic view illustrating the transverse planar member (“tray”) of my invention.

FIG. 1B provides a perspective schematic view from the side and below of the transverse planar member (“tray”) of my invention.

FIG. 2A provides a first side perspective schematic view of the planar member as used in conjunction with a rod holder.

FIG. 2B provides a second perspective schematic view from the side and above of the planar member as used in conjunction with a rod holder.

FIG. 3A provides a perspective schematic view from the side and below the planar member as used in conjunction with a rod holder.

FIG. 3B provides a perspective schematic view from the side and above the planar member as used in conjunction with a rod holder

FIG. 4A provides a perspective schematic vi w from the side and above of the planar member as used in conjunction with a rod holder further illustrating the purpose and use of various features of the invention.

FIG. 4B provides an alternate perspective schematic view from the side and above of the planar member as used in conjunction with a rod holder further illustrating the purpose and use of various features of the invention.

### DESCRIPTION

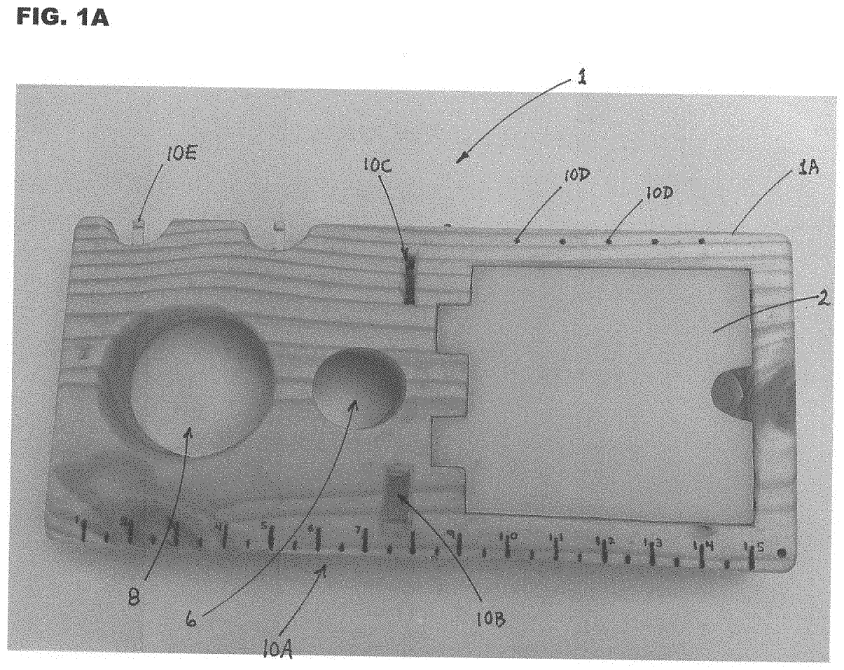

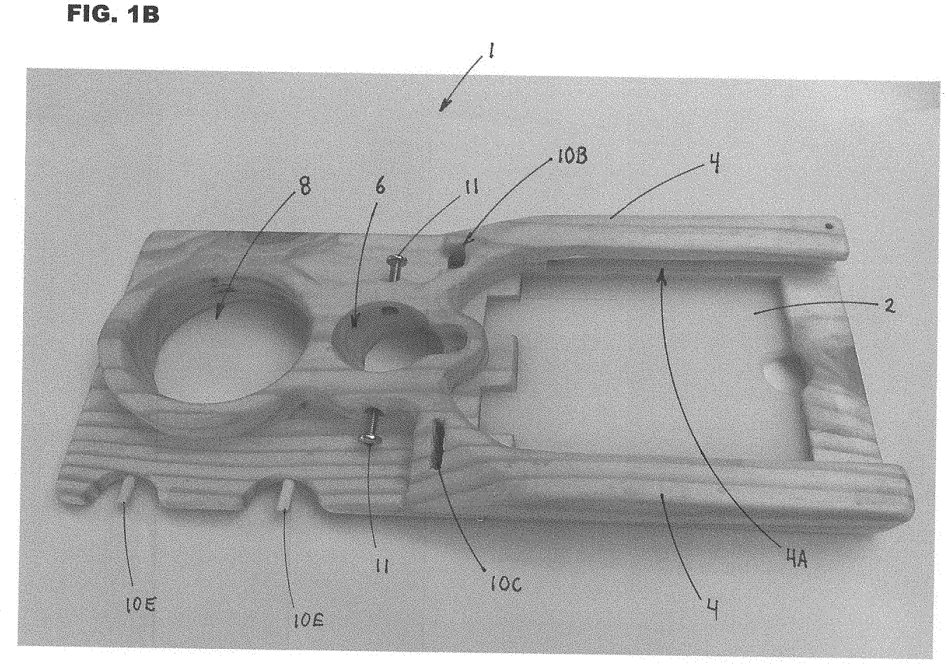

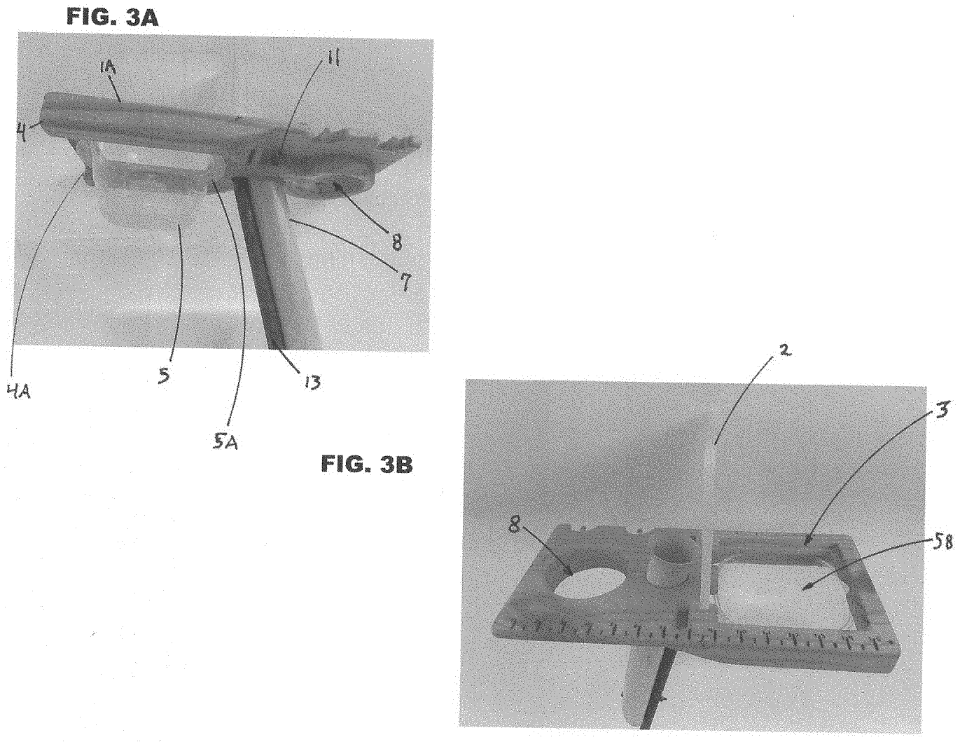

FIGS. 1A through 3B illustrate the primary components of my invention. First, and most obviously, it is comprised of a transverse planar member 1 (approximately 8″×16″) having portion of its upper surface 1A provided by a hinged liftable cutting board 2, which cutting board 2 covers a closeable opening 3 in said transverse planar member 1. The closeable opening 3 is closed by lowering said hinged cutting board 2 to close said opening 3 and opened by lifting said cutting board upward to expose said opening 3. Container supports 4 beneath said transverse planar member 1 are adapted to provide support for an open topped removable container 5 beneath said opening 3, which can be slid into position thereon via insertion or its overhanging lip 5A into the grooves 4A provided in supports 4. As illustrated in the drawing figures said removable container 5 has an upper opening 5B that interfaces with the opening 3 in and through said transverse planar member 1. Container 5 is ideally provided by a sealable Tupperware® type container. This allows multiple sealed containers 5 to be carried by the fisherman for easy replacement with similar sealed containers being used to conveniently store different types of, or additional, bait; or food for the fisherman.

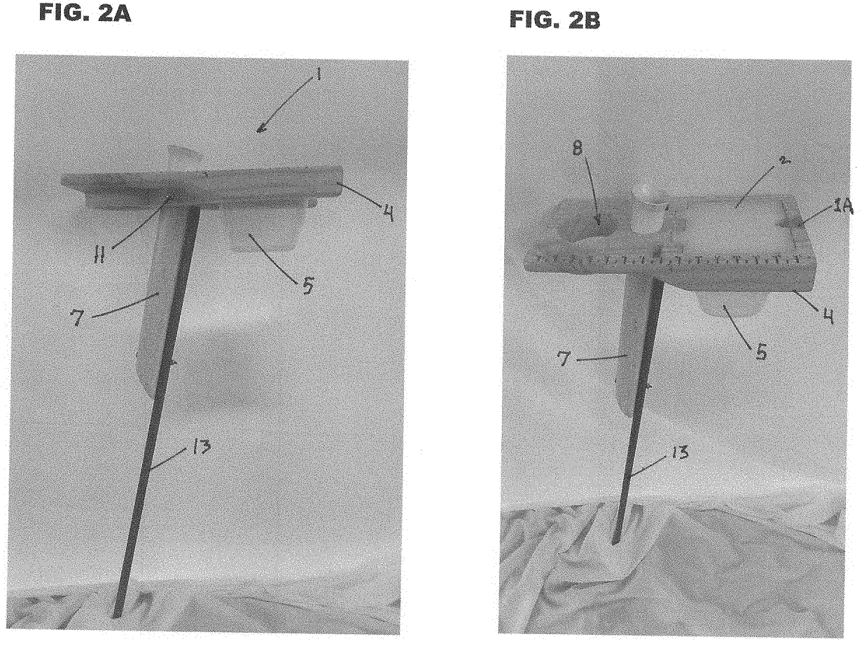

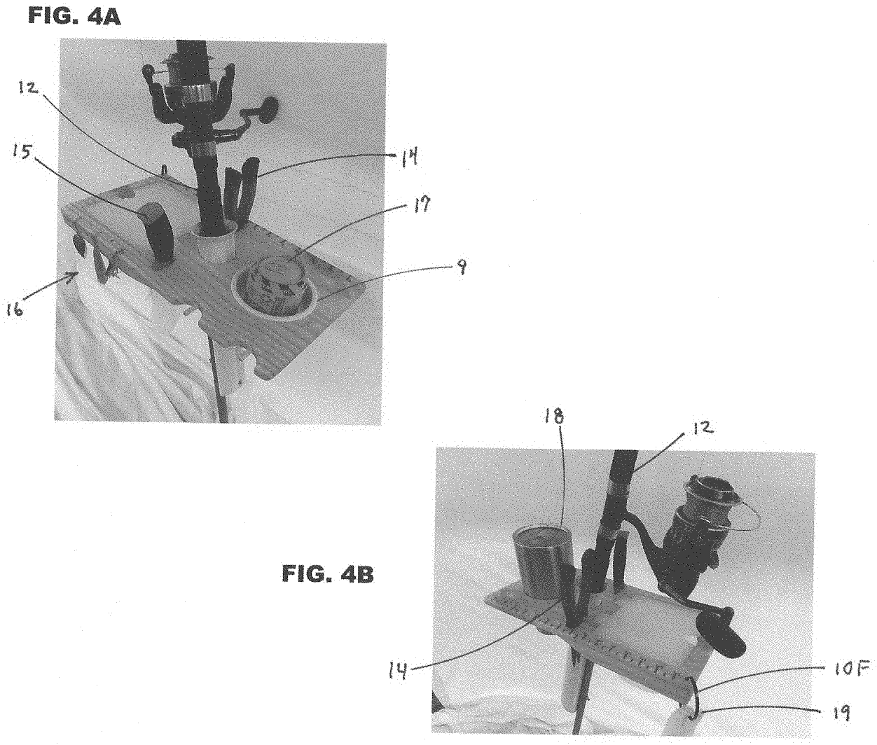

Further, transverse planar member 1 is provided with an inclined rod and reel tube opening 6 (approximately 1 and ⅞″ in diameter) in said planar member 1 for the placement of a tubular member 7 therethrough, which tubular member 7 is sized for insertion of the handle of a fishing rod 12 therein. Opening 6 is inclined at an angle of approximately 15 degrees from the vertical as better seen in FIG. 2A. Likewise, as best seen in FIGS. 1B, 2A and 3A, planar member 1 includes interfacing tightening screws 11 on its underside that can be tightened to affix tubular member 7 in position therein. (See, also, FIGS. 4A and 4B illustrating method of use).

Further review of FIG. 1 will provide insight into the many other features provided in the planar member 1 of the invention. First, there is an incorporated ruler 10A along one side for measuring “the catch” and for other purposes related to the purposes of the invention. Second, there is an appropriately sized pliers slot 10B for insertion and holding a pair of pliers 14 for use in removing hooks and other tasks. (See, e.g., FIGS. 4A and 4B for method of use). Third, there is an appropriately sized knife slot 10C for insertion and holding a knife 15 for use in cutting bait, cleaning fish, cutting line, and other tasks. (See, e.g., FIGS. 4A and 4B for method of use). Fourth, on the opposite side from the ruler, there are a series of small fishing hook holes 10D sized for insertion and holding of hooks and lures 16. (See, e.g., FIG. 4A illustrating method of use). Fifth, there are also located on the same side, all-purpose hooks 10E for hanging miscellaneous items as needed. Sixth, opposite the cutting board end of the planar member 1, there is a large opening 8 (approximately 3.5″ in diameter) sized for holding either a standard plastic insert 9 for cups and cans 17 (as illustrated in FIG. 4A), or (with said insert removed) holding a large thermal cup/mug 18 (as illustrated in FIG. 4B). Seventh, there is a ring 10F provided at the forward end for holding a towel 19 or other item. (See, e.g., FIGS. 4A and 4B illustrating method of use).

### PARTS LIST

1 transverse planar member
1A upper surface of transverse planar member
2 liftable cutting board 2
3 closeable opening in transverse planar member 1
4 container supports beneath transverse planar member 1
4A grooves in container supports
5 container
5A overhanging lip of container 5
5B upper opening of container 5
6 rod and reel tube opening
7 tubular member
8 cup hole openings
9 Cup hole insert
10A ruler
10B pliers slot
10C knife slot
10D fishing hook holes
10E all-purpose hooks
10F towel ring
11 tightening screw
12 rod and reel
13 stake
14 pliers
15 knife
16 hooks and lures
17 can
18 thermal mug
19 towel

However, numerous variations are possible without deviating from and/or exceeding the spirit and scope of the invention. Moreover, many of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the claims.

I claim:

1. A Multipurpose Fishing Rod Holder, comprising:
A horizontal planar member having an upper horizontal surface, where a portion of said upper surface has an opening therethrough, which opening is covered by a liftable cutting board;
an inclined removable tubular member through and transverse to said planar member, which tubular member is sized for insertion of the handle of a fishing rod therein;
a stake attached to and aligned with said tubular member, which stake is adapted for driving into an earthen surface for mounting the said planar member in spaced horizontal relationship to said earthen surface; and
a removable container with an open interior and top positionable under said opening such that said opening is in communication with the interior of said container.

2. The Multipurpose Fishing, Rod holder of claim 1, wherein at least one of:
said liftable, cutting board is hinged to said upper surface proximate to said tubular member,
said planar member includes supports for said removable container to hold it in position beneath said opening,
said planar members includes supports for said removable container to hold it in position beneath said opening and said supports allow said container to slide into and out of said position,
said container is a sealable container, including a sealable top for placement on said container when it is separated from said planar member,

3. The Multipurpose Fishing Rod holder of claim 1, wherein at least one of:
the upper surface of said planar member is approximately 8″ by 16″,
a ruler is incorporated into the upper surface of said planar member along one edge thereof,
a slot for holding a pair of pliers is incorporated into said planar member,
a knife slot for insertion and holding a knife is incorporated into said planar member,
a series of small fishing hook holes sized for insertion and holding of hooks and lures is incorporated into said planar member,
all-purpose hooks for hanging miscellaneous items depend from said planar member, and
at least one towel or rag ring depends from said planar member.

4. The Multipurpose Fishing Rod holder of claim 2, wherein at least one of:
the upper surface of said planar member is approximately 8″ by 16″,
a ruler is incorporated into the upper surface of said planar member along one edge thereof,
a slot for holding a pair of pliers is incorporated into said planar member,
a knife slot for insertion and holding a knife is incorporated into said planar member,
a series of small fishing hook holes sized for insertion and holding of hooks and lures is incorporated into said planar member,
all-purpose hooks for hanging miscellaneous items depend from said planar member, and
at least one towel or rag ring depends from said planar member.

5. The Multipurpose Fishing Rod holder of claim 1, further comprising:
an opening in said horizontal planar member approximately 3.5″ in diameter;
a plastic insert, which insert can be fitted into said opening; and
wherein with said plastic inserted therein, cups and drink cans can be held therein, and without such insert placed therein, said opening can accommodate a large thermal cup/mug.

6. The Multipurpose Fishing Rod holder of claim 2, further comprising:
an opening, in said horizontal planar member approximately 3.5″ in diameter;
a plastic insert, which insert can be fitted into said opening; and
wherein with said plastic inserted therein, cups and drink cans can be held therein, and without such insert placed therein, said opening can accommodate a large thermal cup/mug.

7. The Multipurpose Fishing Rod holder of claim 3, further comprising:
an opening in said horizontal planar member approximately 3.5″ in diameter;
a plastic insert, which insert can be fitted into said opening; and
wherein with said plastic inserted therein, cups and drink cans can be held therein, and without such insert placed therein, said opening can accommodate a large thermal cup/mug.

8. The Multipurpose Fishing Rod holder of claim 4, further comprising:
an opening in said horizontal planar member approximately 3.5″ in diameter;
a plastic insert, which insert can be fitted into said opening; and
wherein with said plastic inserted therein, cups and drink cans can be held therein, and without such insert placed therein, said opening can accommodate a large thermal cup/mug.
